(19) United States
(12) Patent Application Publication
(10) Pub. No.: US 2014/0246460 A1
(43) Pub. Date: Sep. 4, 2014

(54) DEVICE FOR LOCKING PUMP

(71) Applicants: Young Joo Lee, (US); Jae Kwang Hwang, (US)

(72) Inventor: Young Joo Lee, Gyeonggi-do (KR)

(73) Assignees: Young Joo Lee, Gyeonggi-do (KR); Jae Kwang Hwang, Seoul (KR)

(21) Appl. No.: 13/976,256

(22) PCT Filed: Sep. 9, 2011
(86) PCT No.: PCT/KR2011/006708

§ 371 Date: May 19, 2014

(30) Foreign Application Priority Data
Dec. 28, 2010 (KR) 10-2010-0136287

(51) Int. Cl. B05B 11/00

(52) U.S. Cl. CPC B05B 11/306
USPC 222/153.13; 222/384

(57) ABSTRACT

The present invention relates to a device for locking a pump by sliding a locking member to both sides, wherein the locking member is slid to the left and the right within a ring-shaped protruding base that is formed on the upper surface of a container lid, and sliding protrusions on both sides of the locking member are arranged so as to be visible on the exterior of a cover member, thereby effectively locking to prevent pumping or unlocking the pump, by simply and conveniently sliding the locking member to the left and the right as needed.

### TECHNICAL FIELD

The present invention relates to a device for locking a pump and more specifically, to a device for locking a pump or unlocking a pump by sliding a locking member to both sides.

### BACKGROUND ART

In general, contents of liquid phase, paste phase or gel phase are contained in a container to be stored and distributed. Especially, contents that have viscosity such as cream, lotion, rinse, shampoo, hair gel, etc. are contained in a pressurizing-type pumping device to be stored and distributed, which are mainly pumped by pushing action of a press button. In a pressurizing type-pumping device, a certain amount of contents contained within a container is pumped and ejected outside through a nozzle with a pressurizing force, when a user pushes a press button manually.

FIGS. 7 to 8 show a pressurizing-type pumping device according to a related art.

First, referring to FIGS. 7 to 8, a pressurizing-type pumping device according to a related art includes: a container body 10 that generally contains contents; a pumping means 20 that is embedded through an upper part of the container body 10, and intakes and pumps contents with a pressurizing force; and a press button 30 which provides pressurizing force to the pumping means 20 and with which a nozzle 35 for ejecting contents outside is provided. Currently, various technologies have been tried and applied to the structure of the pumping means 20. FIG. 8 shows a structure of the pumping means 20 that has been most commonly used according to a related art. A brief description of operating procedures of the pumping means 20 is as the follow.

When a user pushes a press button 30 manually, a pressurizing force is transferred to a piston member 24, thereby contracting an elastic member 23. At this time, a certain amount of contents filled in a cylinder 21 will rise along a guide tube 25 and then will be ejected outside through a nozzle 35. Additionally, when the pressurizing force is released, the contents contained within the container body 10 is inhaled and filled in the cylinder 21 while the piston member 24 rises upwardly by means of an elastic force of the elastic member 23. In FIG. 8, reference numeral 22 refers to a ball valve that blocks an inlet of the cylinder such that contents filled in the cylinder may not drop downwardly when the press button 30 is pushed, and reference numeral 29 refers to an intake tube that is communicated with the cylinder 22 and intakes the contents in the container body 10.

There is an advantage in the pressurizing-type pumping device that a certain amount of contents contained in a container is ejected easily with a pushing action.

However, a conventional pumping device of a related art shown in FIGS. 7 to 8 has no additional locking device while the nozzle 35 is communicated with the guide tube 25, and thus the contents may be ejected and wasted contrary to the purpose when the press button 30 is pushed while unnecessary external force applies thereto in carrying and storing the container. Moreover, foreign substance may be introduced to the container through the nozzle 35. At this time, an additional closing cap is provided thereto in order to prevent the ejection of the contents and water inflow and thus cost for forming separately the closing cap increase and it is inconvenient to open and close the closing cap.

### DISCLOSURE

### Technical Problem

The present invention has been made in an effort to solve the above-described problems associated with prior art and it is an object of the present invention to provide a device for locking a pump, capable of simply and conveniently locking or unlocking a pump container by sliding a locking member to both sides.

### Technical Solution

According to an aspect of the first exemplary embodiment of the present invention, the device for locking a pump may include: a press button provided with a lower outer diameter portion that is fitted into a top of a pump shaft within a container for ejecting outside the contents within the container; and a locking device that is arranged on an outer peripheral surface of the lower outer diameter portion in a cylindrical shape of the press button to control up and down movement of the press button, wherein the locking device is composed of: a ring-shaped protruding base which is protruded on a top surface of a container lid and on both sides of which openings are formed symmetrically; a locking member that is inserted into the inside of the ring-shaped protruding base to control up and down movement of the lower outer diameter portion of the press button, which is inserted into the center of the container lid, while sliding to the left and the right to the openings; and a cover member which covers the ring-shaped protruding base in which the locking member is arranged, and on an inner peripheral surface of which the protrusions that are inserted into a pair of symmetrical grooves formed on an outer peripheral surface of the ring-shaped protruding base, respectively.

According to another aspect of the first exemplary embodiment of the present invention, the locking member may include: sliding protrusions in a shape of a rectangular bar that are formed at both sides so as to be inserted into the openings of the ring-shaped protruding base; a ring-shaped portion that is formed in a ring shape between the sliding protrusions by connecting the inner peripheral surfaces having inner diameters of two kinds; and stopper protrusions that are formed symmetrically at both sides of the outer circumference surfaces of the ring-shaped portion to control up and down movement of the press button with contacting inner protrusions that are formed symmetrically on inner peripheral surfaces of the ring-shaped protruding base of the container lid.

According to still another aspect of the first exemplary embodiment of the present invention, the inner peripheral surface of the ring-shaped portion may be shaped by two types of circles with an eccentricity wherein it is composed of: a first inner diameter portion that is formed between the stopper protrusions, has a smaller diameter than an outer diameter of the lower outer diameter portion of the press button and is disposed at the bottom surface of the lower outer diameter portion to control the down movement of the press button; and a secondary diameter portion which is formed eccentrically at one side of the first inner diameter portion and into which the lower outer diameter portion of the press button that is larger than the first inner diameter portion.

### Advantageous Effects

According to the device for locking a pumping of the present invention, the locking member is slid to the left and the right within a ring-shaped protruding base that is formed on the upper surface of a container lid, and sliding protrusions at both sides of the locking member are arranged so as to be visible on the exterior of a cover member, thereby the device has advantages of effectively locking the pump to locking a pumping or unlocking the pumping, by simply and conveniently sliding the locking member to the left and the right as needed.

### BRIEF DESCRIPTION OF THE DRAWINGS

FIG. 1 is an exploded perspective view of a device for locking a pump according to an embodiment of the present invention.

FIG. 2 is an assembly perspective view of the device for locking a pump according to an embodiment of the present invention.

FIG. 3 is a perspective view of a press button in a locking state of a pump container according to an embodiment of the present invention.

FIG. 4 is a perspective view of a press button in a pushed state of the pump container according to an embodiment of the present invention.

FIG. 5 is a sectional view of a press button in a locking state of a pump container according to an embodiment of the present invention.

FIG. 6 is a sectional view of a press button of the pump container in a pushed state according to an embodiment of the present invention showing a condition of being pressed.

FIG. 7 is a perspective view of a pressuring-type pumping device according to related art.

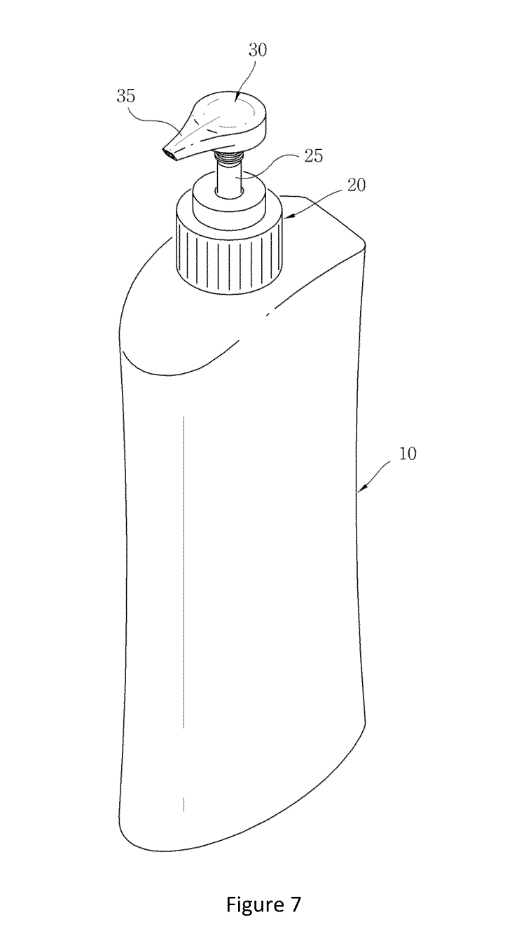

FIG. 8 is a sectional view of a pressuring-type pumping device according to related art.

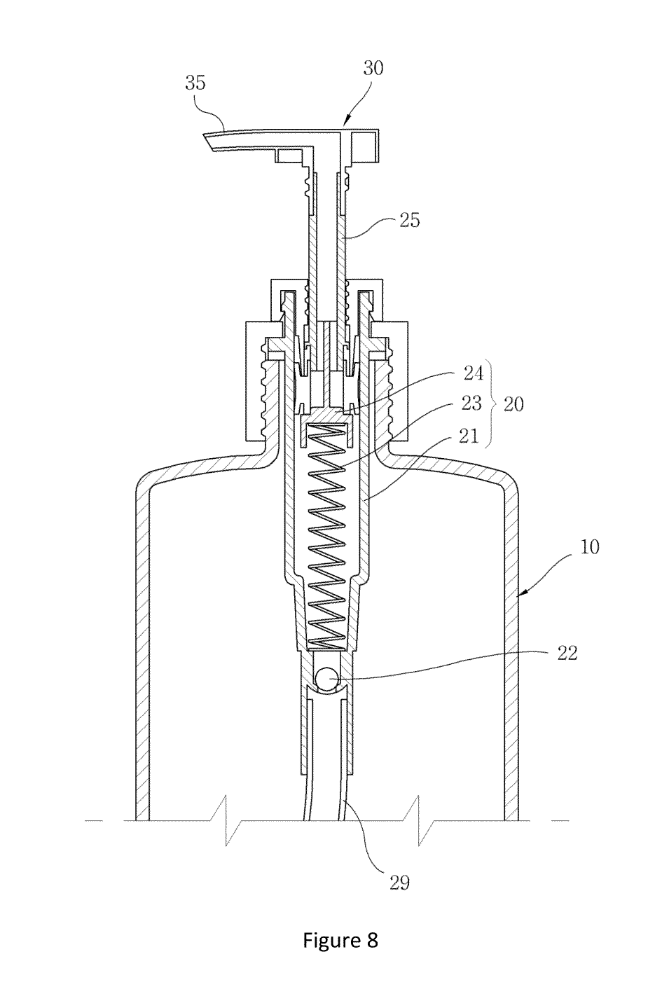

### BEST MODE FOR THE INVENTION

The device for locking a pump according to a first embodiment of the present invention includes: a press button provided with a lower outer diameter portion that is fitted into a top of a pump shaft within a container for ejecting outside the contents within the container; and a locking device that is arranged on an outer peripheral surface of the lower outer diameter portion in a cylindrical shape of the press button to control up and down movement of the press button, wherein the locking device is composed of: a ring-shaped protruding base which is protruded on a top surface of a container lid and on both sides of which openings are formed symmetrically; a locking member that is inserted into the inside of the ring-shaped protruding base to control up and down movement of the lower outer diameter portion of the press button, which is inserted into the center of the container lid, while sliding to the left and the right to the openings; and a cover member which covers the ring-shaped protruding base in which the locking member is arranged, and on an inner peripheral surface of which the protrusions that are inserted into a pair of symmetrical grooves formed on an outer peripheral surface of the ring-shaped protruding base, respectively.

### MODE FOR THE INVENTION

Hereinafter, exemplary embodiments of the present invention will be described below in more detail with reference to the accompanying drawings.

It should be understood that different embodiments of the invention, including those described under different aspects of the invention, are meant to be generally applicable to all aspects of the invention. Any embodiment may be combined with any other embodiment unless inappropriate. All examples are illustrative and non-limiting.

### Embodiment

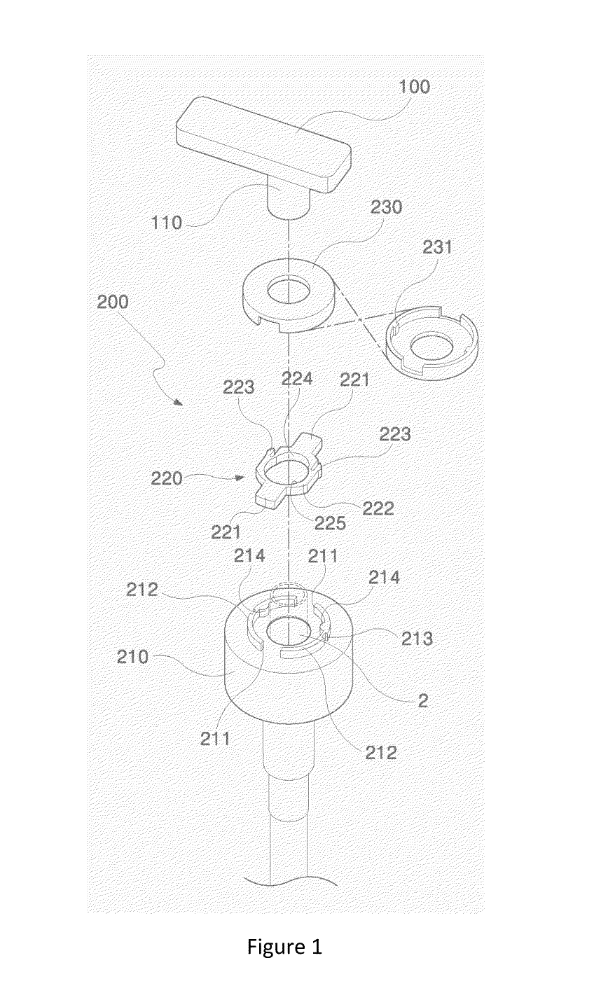

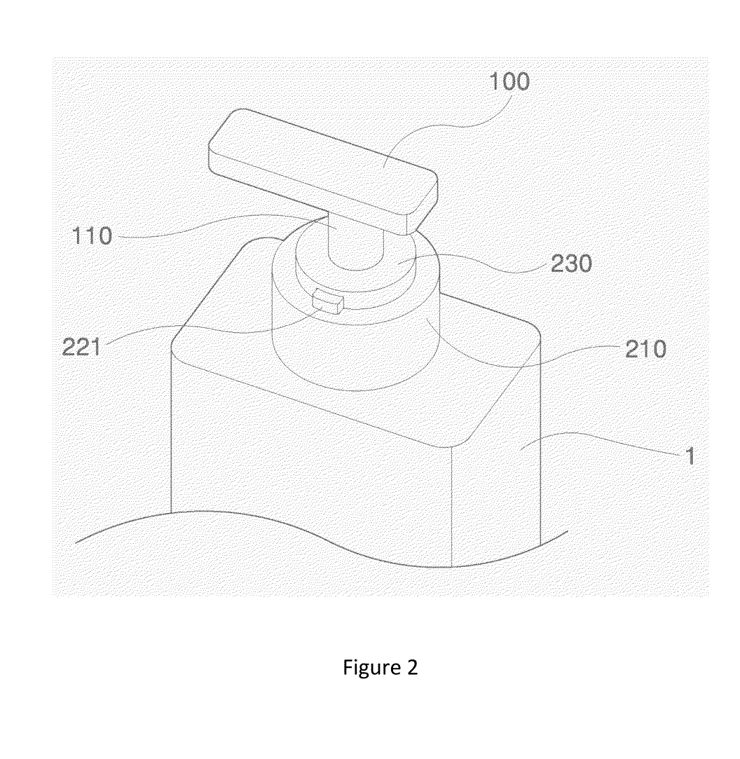

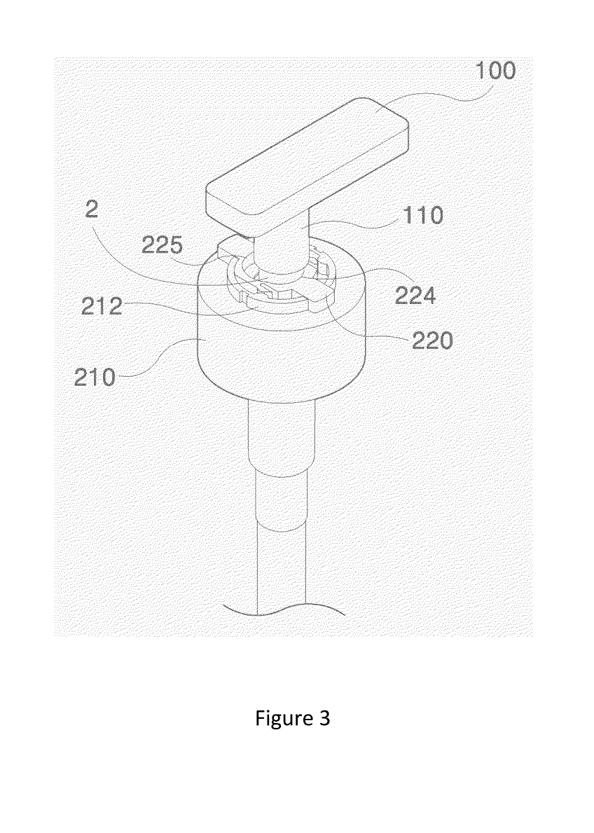

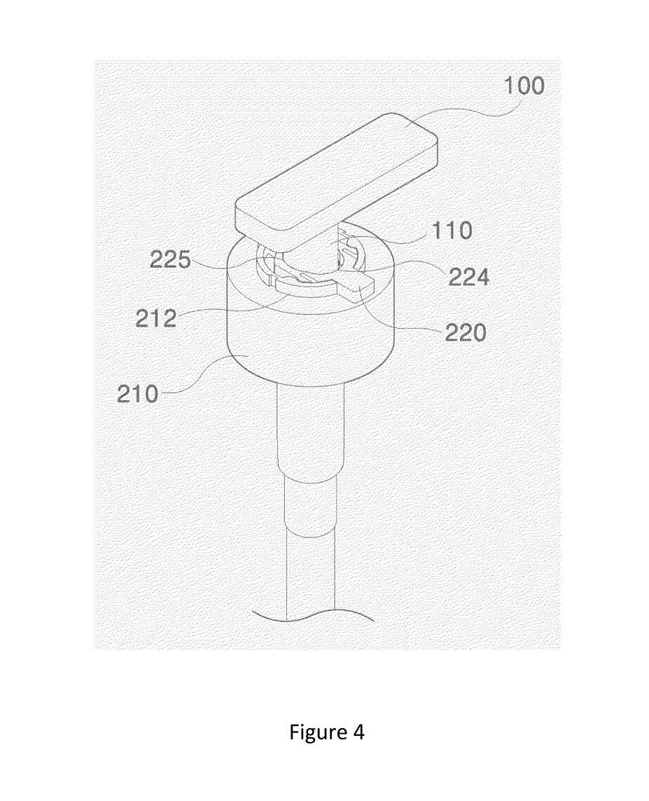

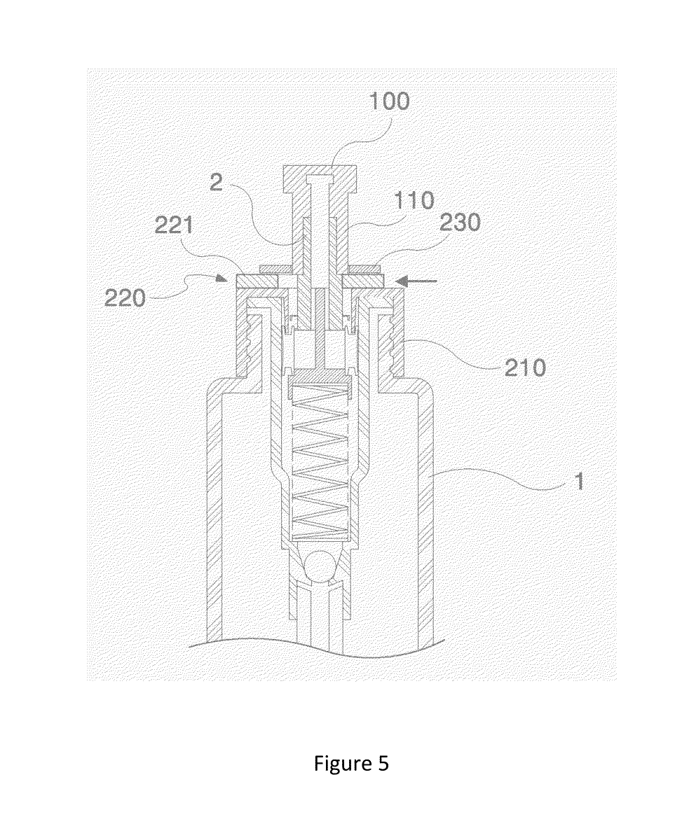

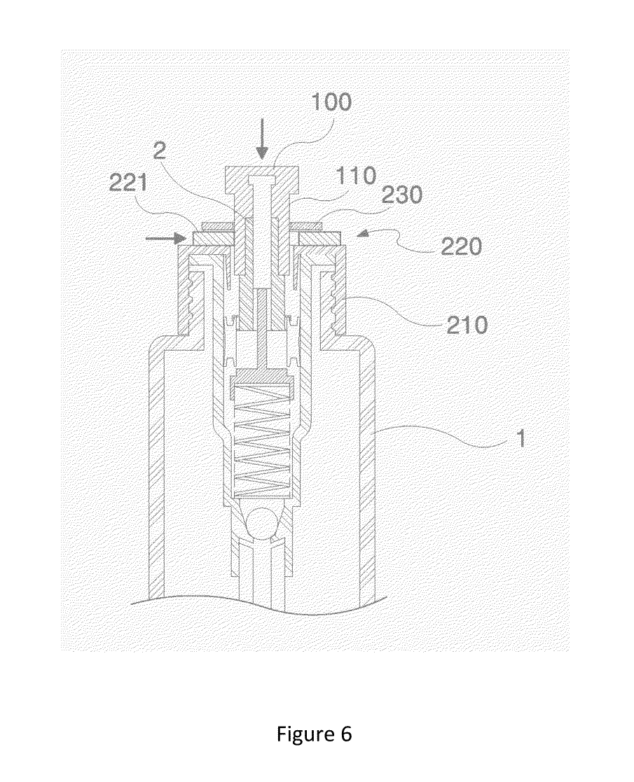

FIG. 1 is an exploded perspective view of a device for locking a pump according to an embodiment of the present invention, FIG. 2 is an assembly perspective view of the device for locking a pump according to an embodiment of the present invention, FIG. 3 is a perspective view of a press button in a locking state of a pump container according to an embodiment of the present invention, FIG. 4 is a perspective view of a press button in a pushed state of the pump container according to an embodiment of the present invention, FIG. 5 is a sectional view of a press button in a locking state of a pump container according to an embodiment of the present invention, and FIG. 6 is a sectional view of a press button of the pump container in a pushed state according to an embodiment of the present invention showing a condition of being pressed.

As shown in the drawings, the device for locking a pump according to a first exemplary embodiment of the present invention includes: a press button 100 provided with a lower outer diameter portion 110 that is fitted into a top of a pump shaft 2 within a container 1 for ejecting outside the contents within the container 1; and a locking device 200 that is arranged on an outer peripheral surface of the lower outer diameter portion 110 in a cylindrical shape of the press button 100 to control up and down movement of the press button 100.

The locking device 200 includes: a ring-shaped protruding base 212 which is protruded on a top surface of the container lid 210 and on both sides of which openings 211 are formed symmetrically; a locking member 220 that is inserted into the inside of the ring-shaped protruding base 212 to control up and down movement of the lower outer diameter portion 110 of the press button 100, which is inserted into the center of the container lid 210, while sliding to the left and the right to the openings 211; and a cover member 230 that covers the ring-shaped protruding base 210 in which the locking member 220 is arranged.

Protrusions 231 that are inserted into a pair of symmetrical grooves 213 formed on an outer peripheral surface of the ring-shaped protruding base 210, respectively, are formed on the inner peripheral surface of the cover member 230.

The locking member 220 is composed of: sliding protrusions 221 in a shape of a rectangular bar that are formed at both sides so as to be inserted into the openings 211 of the ring-shaped protruding base 210; a ring-shaped portion 222 that is formed in a ring shape between the sliding protrusions 221 by connecting the inner peripheral surfaces having inner diameters of two kinds; and stopper protrusions 223 that are formed symmetrically at both sides of the outer circumference surfaces of the ring-shaped portion 222 to control up and down movement of the press button 100 with contacting inner protrusions 214 that are formed symmetrically on inner peripheral surfaces of the ring-shaped protruding base 212 of the container lid 210.

The inner peripheral surface of the ring-shaped portion 222 is shaped by two types of circles with an eccentricity wherein it is composed of: a first inner diameter portion 224 that is formed between the stopper protrusions 223, has a smaller diameter than an outer diameter of the lower outer diameter portion 110 of the press button 100 and is disposed at the bottom surface of the lower outer diameter portion 110 to control the down movement of the press button 100; and a secondary diameter portion 225 which is formed eccentrically at one side of the first inner diameter portion 224 and into which the lower outer diameter portion 110 of the press button 100 that is larger than the first inner diameter portion 224.

The operation of the device for locking a pump according to an embodiment of the present invention will be described as following. The cover member 230 is assembled to the pump shaft such that the sliding protrusions 221 at both sides of the locking member 220 are arranged to be disposed in the openings 211 at both sides of the ring-shaped protruding base 214, which are formed at a top of the container lid 210, respectively, and the protrusions 231 that are formed on an inner peripheral surface of the cover member 230 are inserted into the grooves 213 that are formed on an outer peripheral surface of the ring-shaped protruding base 214.

Under the condition of such an assemblage, the lower outer diameter portion 110 of the press button 100 is inserted into an upper end of the pump shaft 2 of the container 1 after passing through the cover member 230, the secondary inner diameter portion 224, 225 of the locking member 220 and the center of the container lid 210, and accommodating the top of a pump shaft 2 of the container 1.

Additionally, as shown in FIG. 3 and FIG. 4, when the sliding protrusion 221 at a side where the stopper protrusion 223 is formed, among the sliding protrusions 221 that are protruded toward both sides of the cover member 230, is pushed to the inner side of the cover member 230 in order to lock a pressing operation of the press button 100, the stopper protrusion 223 that is formed protrudingly on an outer peripheral surface of the ring shaped-portion 222 of the locking member 220 rides over an inner peripheral surface protrusion 214 on an inner peripheral surface of the ring-shaped protruding base 212, with being in contact therewith, and the first inner diameter portion 224 of the ring-shaped portion 222 is to be disposed on an outer peripheral surface of the pump shaft 2.

When the press button 100 is pushed under the condition as described above, the lower end surface of the lower outer diameter portion 110 is caught over an upper surface of the locking member 220, and thus the press button cannot be operated anymore.

Furthermore, as shown in FIGS. 4 and 6, on the contrary, when the sliding protrusion 221 at an opposite side where the stopper protrusion 221 of the locking member 220 is not formed, is pushed toward an inner side of the cover member 230 in order to unlock the pressing operation of the press button 100, the stopper protrusion 223 that is formed protrudingly on an outer peripheral surface of the ring shaped-portion 222 of the locking member 220 rides over toward an opposite direction, that is, toward an outer direction of the inner peripheral surface protrusion 214, with being in contact with the inner peripheral surface protrusion 214 on an inner peripheral surface of the ring-shaped protruding base 212, and the stopper protrusion is to be disposed on an inner peripheral surface of the secondary inner diameter portion 224 having a diameter for the secondary inner diameter portion 224 of the locking member 220, that is, the lower outer diameter portion 110 of the press button 100 to be inserted, and thus the press button 100 is to be operated.

As described above, whether the pressing operation of the press button 100 is locked or unlocked can be conformed easily by sliding the locking member 220 to the left and the right within the ring-shaped protruding base 212 that is formed on the upper surface of the container lid 210 and by arranging the sliding protrusions 221 at both sides of the locking member 220 to be visible on an exterior of the cover member 230.

The locking member is slid to the left and the right within a ring-shaped protruding base that is formed on the upper surface of a container lid, and the sliding protrusions on both sides of the locking member are arranged so as to be visible on the exterior of a cover member, thereby a pumping is locked or unlocked, by simply and conveniently sliding the locking member to the left and the right as needed.

While the present invention has been described with respect to the specific embodiments, it will be apparent to those skilled in the art that various changes and modifications may be made without departing from the spirit and scope of the invention as defined in the following claims.

1. A device for locking a pump, comprising: a press button (100) provided with a lower outer diameter portion (110) that is fitted into a top of a pump shaft (2) within a container (1) for ejecting outside the contents within the container (1); and a locking device (200) that is arranged on an outer peripheral surface of the lower outer diameter portion (110) in a cylindrical shape of the press button (100) to control up and down movement of the press button (100), wherein the locking device (200) is composed of: a ring-shaped protruding base (212) which is protruded on a top surface of a container lid (210) and on both sides of which openings (211) are formed symmetrically; a locking member (220) that is inserted into the inside of the ring-shaped protruding base (212) to control up and down movement of the lower outer diameter portion (110) of the press button (100), which is inserted into the center of the container lid (210), while sliding to the left and the right to the openings (211); and a cover member (230) which covers the ring-shaped protruding base (210) in which the locking member (220) is arranged, and on an inner peripheral surface of which the protrusions (231) that are inserted into a pair of symmetrical grooves (213) formed on an outer peripheral surface of the ring-shaped protruding base (210), respectively.

2. The device for locking a pump of claim 1, wherein the locking member (220) comprises: sliding protrusions (221) in a shape of a rectangular bar that are formed at both sides so as to be inserted into the openings (211) of the ring-shaped protruding base (210); a ring-shaped portion (222) that is formed in a ring shape between the sliding protrusions (221) by connecting the inner peripheral surfaces having inner diameters of two kinds; and stopper protrusions (223) that are formed symmetrically at both sides of the outer circumference surfaces of the ring-shaped portion (222) to control up and down movement of the press button (100) with contacting inner protrusions (214) that are formed symmetrically on inner peripheral surfaces of the ring-shaped protruding base (212) of the container lid (210).

3. The device for locking a pump of claim 2, wherein the inner peripheral surface of the ring-shaped portion (222) is shaped by two types of circles with an eccentricity wherein it is composed of: a first inner diameter portion (224) that is formed between the stopper protrusions (223), has a smaller diameter than an outer diameter of the lower outer diameter portion (110) of the press button (100) and is disposed at the bottom surface of the lower outer diameter portion (110) to control the down movement of the press button (100); and a secondary diameter portion (225) which is formed eccentrically at one side of the first inner diameter portion (224) and into which the lower outer diameter portion (110) of the press button (100) that is larger than the first inner diameter portion (224).
